(19) United States
(12) Patent Application Publication
(10) Pub. No.: US 2007/0275605 A1
(43) Pub. Date: Nov. 29, 2007

(54) Electrical Connector for Connecting a Cable to a Circuit Board

(76) Inventors: George Hubbard, Morgantown, IN (US); Edmund W.M. Poh, Lisle, IL (US); James L. McGrath, Bloomingdale, IL (US); David S. McCallum, West Chicago, IL (US)

Correspondence Address: MOLEX INCORPORATED, 2222 WELLINGTON COURT, LISLE, IL, 60532, US

(21) Appl. No.: 10/530,915

(22) PCT Filed: Feb. 2, 2005
(86) PCT No.: PCT/US05/02809

§ 371 Date: Apr. 2, 2007

Related U.S. Application Data
(60) Provisional application No. 60/541,184, filed on Feb. 2, 2004.
(60) Provisional application No. 60/584,220, filed on Jun. 30, 2004.

(51) Int. Cl. H01R 24/00

(52) U.S. Cl. 439/660

(57) ABSTRACT

A connector is provided for connecting a cable to a printed wiring board. The connector includes a dielectric housing, a conductive signal contact mounted on the housing for mating with a signal conductor of the cable, and a spring connector connected to the housing. The spring connector connects the signal contact on the housing to a signal contact on the printed wiring board.

This application claims the benefit of U.S. provisional application Ser. No. 60/541,184, filed on Feb. 2, 2004 and U.S. provisional application Ser. No. 60/584,220, filed on Jun. 30, 2004.

### FIELD OF THE INVENTION

The present invention provides a connector for connecting a cable to a printed wiring board.

### BACKGROUND OF THE INVENTION

Notebook computers are very popular in today's market because the compactness of the computer. Most notebook computers come with sockets for printed wiring boards, often called cards, to be inserted therein. Electrical connectors are used for connecting the printed wiring board within the socket of the notebook computer for transmitting and/or retrieving electronic data signals. The connector needs to be reliable and needs to be reusable so that a variety of cards can be inserted and replaced. Because cost, weight, and overall size of notebook computers are critical parameters, the connectors must be low cost, light weight, and small size and capable of high volume, short lead time production.

Prior art connectors designed for electrical connection to printed wiring boards normally are mated by the printed wiring board approaching parallel to the main axis of the connector. This can limit the application of the connector in certain situations.

A connector used for connecting the printed wiring board within the socket of the notebook computer is required to have low loss performance at microwave frequencies. This requires careful attention to the control of the characteristic impedance of the connector and the connection to the printed wiring board.

The present invention provides a connector which overcomes the disadvantages in the prior art and provides several advantages over the prior art Such advantages will become apparent upon a reading of the attached specification in combination with a study of the drawings.

### OBJECTS AND SUMMARY OF THE INVENTION

A general object of the present invention is to provide a connector to connect a cable to a printed wiring board.

An object of the present invention is to provide a connector for use in a Wireless Form Factor (“WFF”) card on a notebook computer.

Another object of the present invention is to provide a connector which allows a user to easily insert and remove a printed wiring board from the notebook computer and to replace the printed wiring board with the same or another printed wiring board.

Briefly, and in accordance with the foregoing, the present invention discloses a connector for connecting a cable to a printed wiring board. The connector includes a dielectric housing, a conductive signal contact mounted on the housing for mating with a signal conductor of the cable, and a spring connector connected to the housing. The spring connector connects the signal contact on the housing to a signal contact on the printed wiring board.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a first embodiment of a connector which incorporates the features in accordance with the present invention shown attached to a cable;

FIG. 2 is a top plan view of a printed wiring board used with the first embodiment of the connector shown in FIG. 1;

FIG. 3 is a top plan view of the guide rail system and printed wiring board shown in FIG. 2;

FIG. 4 is a perspective view of the guide rail system and printed wiring board shown in FIG. 2;

FIG. 5 is a perspective view of a housing which forms a portion of the connector shown in FIG. 1, shown attached to a cable;

FIG. 6 is a perspective view of a ground shield which forms a portion of the connector shown in FIG. 1, shown attached to a cable;

FIG. 7 is a rear perspective view of the connector of FIG. 1, shown attached to a cable;

FIG. 8 is a perspective view of a spring connector which forms a portion of the connector shown in FIG. 1;

FIG. 9 is cross-sectional view of the spring connector shown in FIG. 8;

FIG. 10 is a front elevational view of the spring connector shown in FIG. 8;

FIG. 11 is a cross-sectional view of the connector of FIG. 1, shown attached to a cable and to the printed wiring board;

FIG. 12 is a perspective view of a second embodiment of a connector which incorporates the features in accordance with the present invention shown exploded from a printed wiring board which is partially shown in perspective;

FIG. 13 is another perspective view of the connector shown in FIG. 12 shown exploded from the printed wiring board which is partially shown in perspective;

FIG. 14 is a perspective view of the connector shown in FIG. 12 shown assembled with a cable;

FIG. 15 is a perspective view of the connector identical to FIG. 14, but with the cable removed;

FIG. 16 is a perspective view of the connector shown in FIG. 12;

FIG. 17 is a perspective view of the connector shown in FIG. 12 assembled with the printed wiring board;

FIG. 18 is a cross-sectional view of the connector of FIG. 12, shown with the cable attached;

FIG. 19 is a perspective view of a third embodiment of a connector which incorporates the features in accordance with the present invention;

FIG. 20 is an exploded perspective of the components of the connector shown in FIG. 19;

FIG. 21 is a perspective view of a lower body of the connector of FIG. 20;

FIG. 22 is a perspective view of a ground shield shown exploded from the lower and upper bodies for the connector shown in FIG. 19;

FIG. 23 is a cross-sectional view of the connector of FIG. 19;

FIG. 24 is a cross-sectional view of the connector of FIG. 19, shown with a cable, in cross-section, exploded therefrom;

FIG. 25 is a cross-sectional view of a portion of a printed wiring board that is used with the third embodiment of the connector;

FIG. 26 is an exploded perspective view of the printed wiring board, with the connectors of FIG. 19 attached therein, and a portion of the device, such as a notebook computer, into which the printed wiring device is inserted; and

FIG. 27 is a perspective view of the printed wiring board assembled with a portion of the device.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

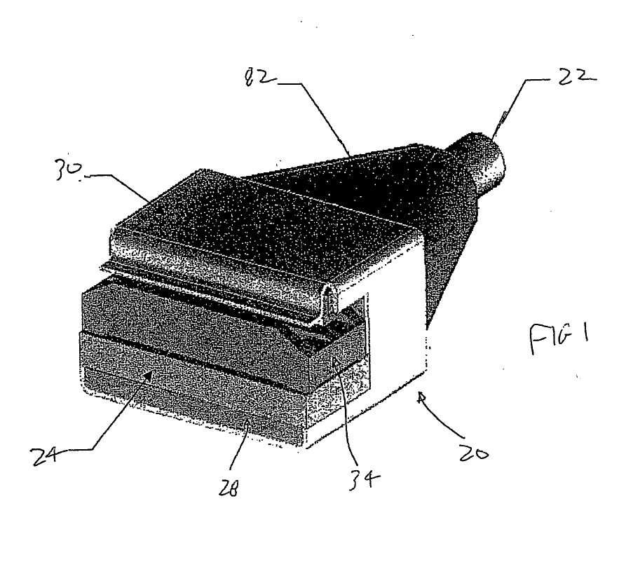

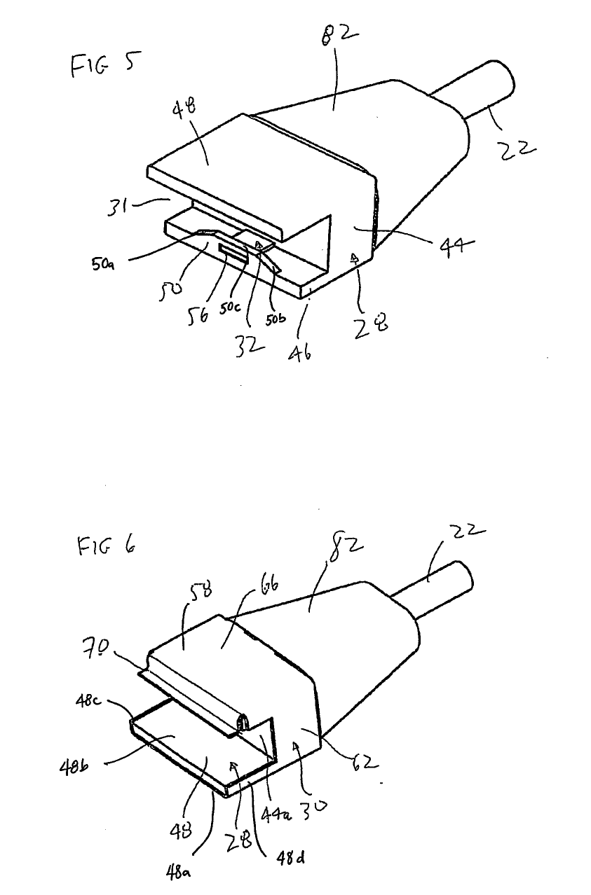

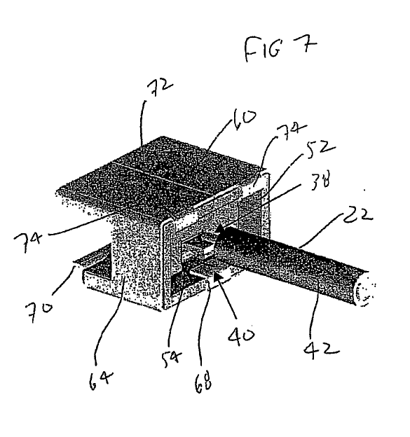

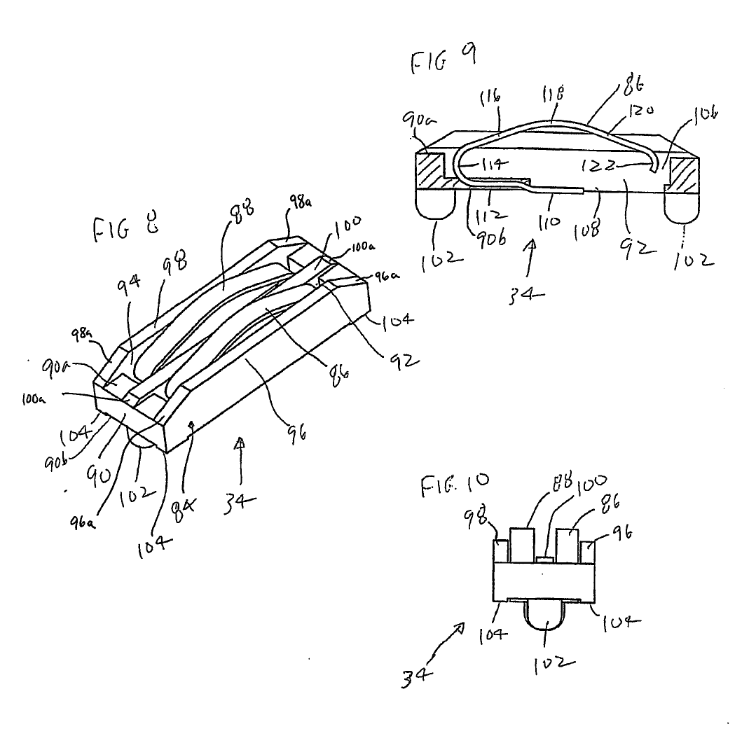

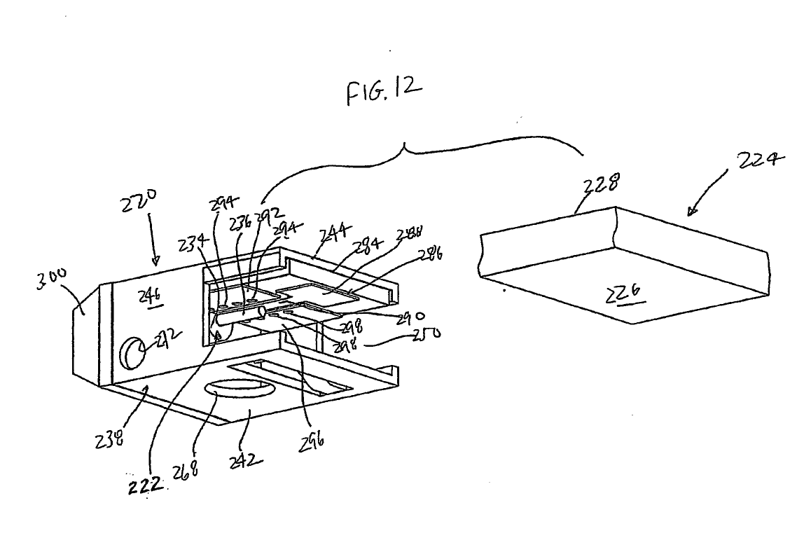

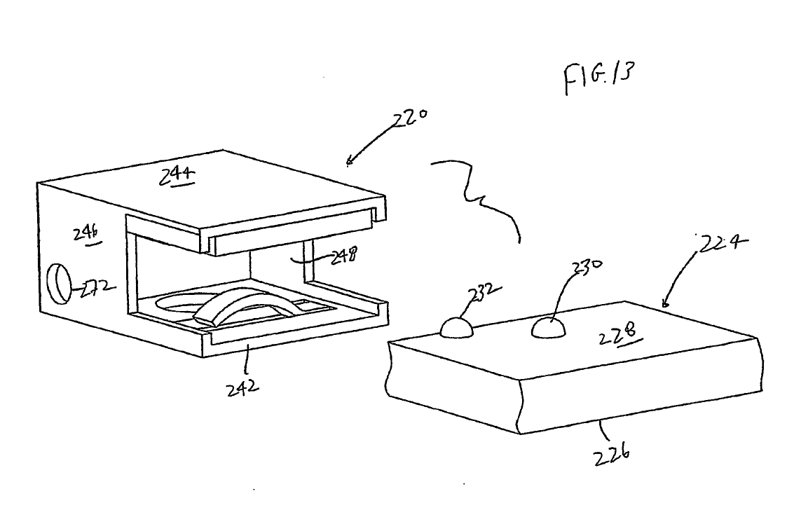

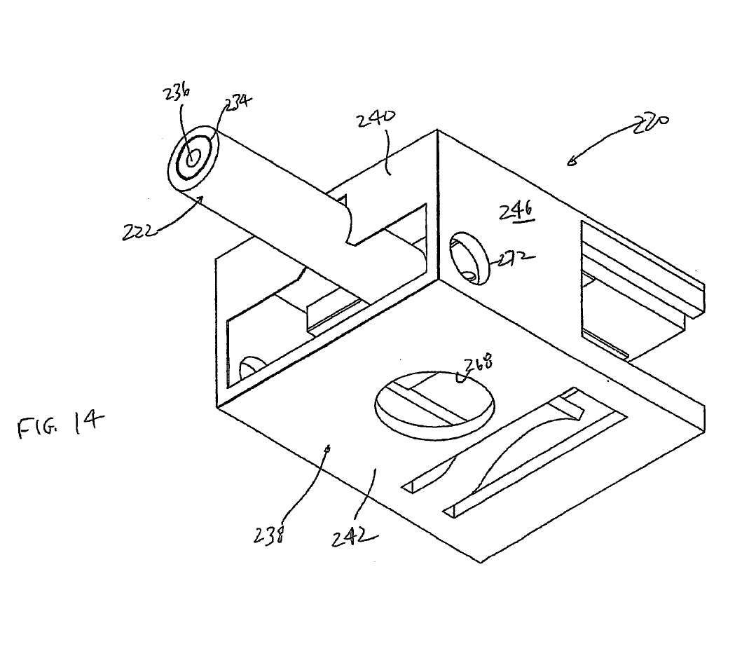

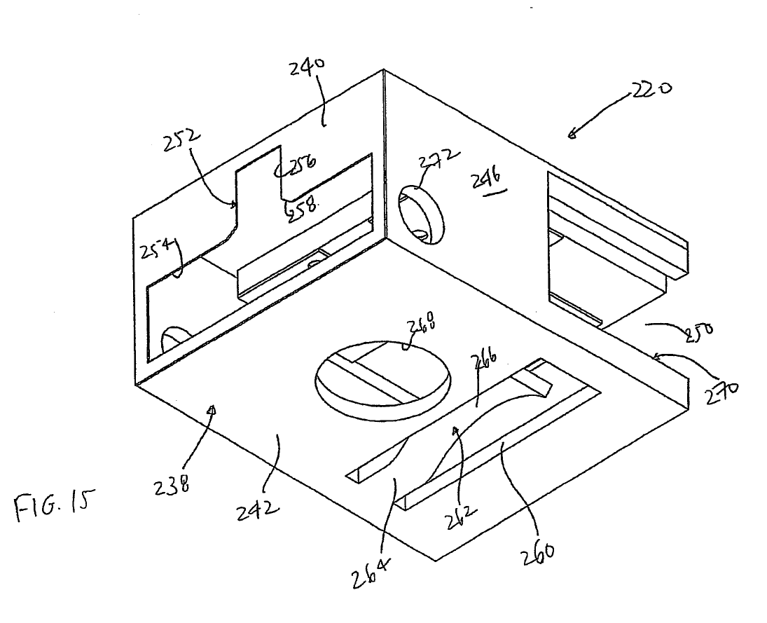

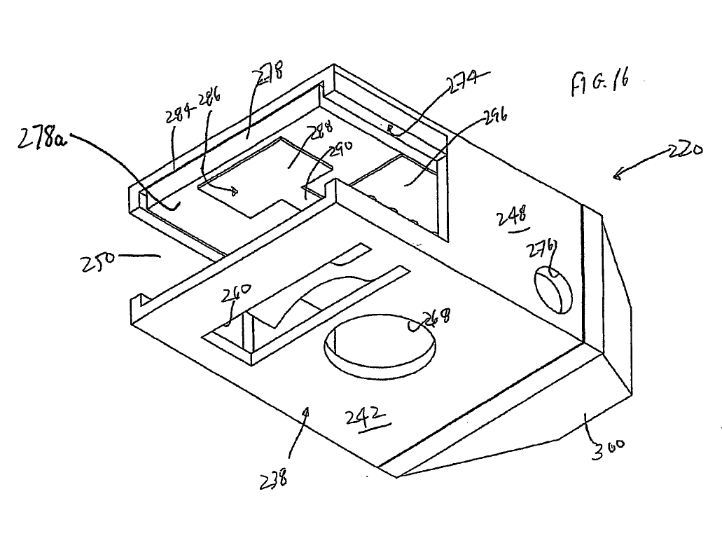

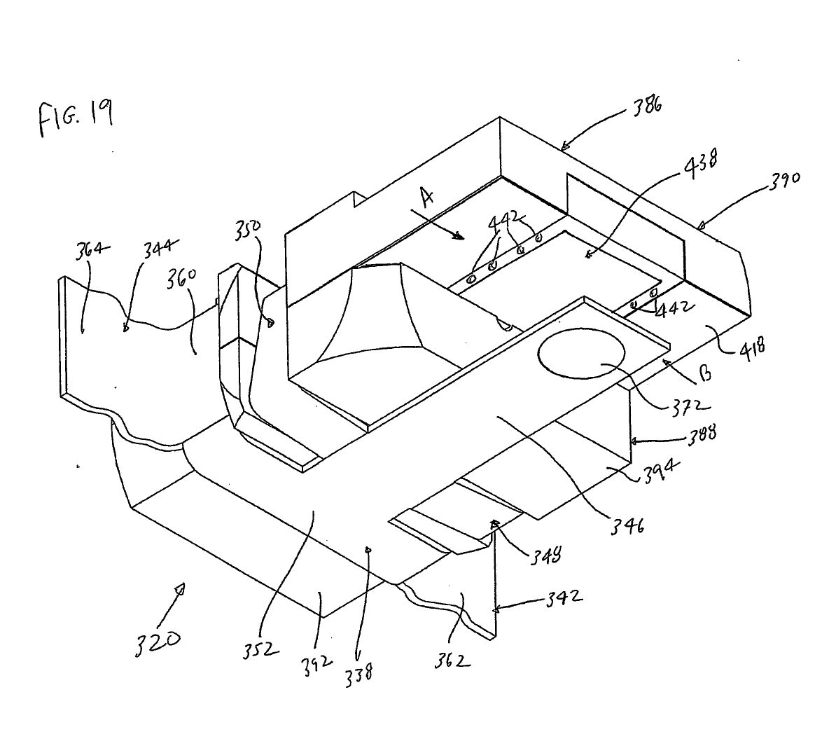

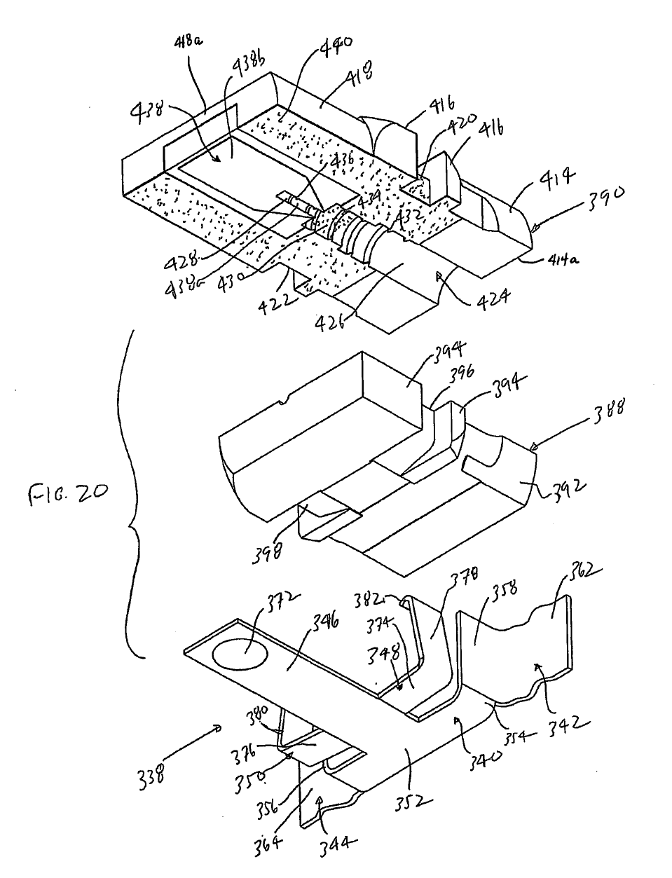

The present invention provides a connector 20, 220, 320 for connecting a cable 22, 222, 322 to a printed wiring board 24, 224, 324. A first embodiment of the connector 20 which incorporates features in accordance with the present invention is shown in FIGS. 1-11; a second embodiment of the connector 220 which incorporates features in accordance with the present invention is shown in FIGS. 12-18; and a third embodiment of the connector 320 which incorporates features in accordance with the present invention is shown in FIGS. 19-27.

The connector 20, 220, 320 is used to connect a cable (coax or any two lead cable) 22, 222, 322, such as a RF (radio frequency) cable, to a printed wiring board 24, 224, 324. The connector 20, 220, 320 is preferably used in a Wireless Form Factor (“WFF”) card on a notebook computer. The printed wiring board 24, 224, 324 can have one or more antennas 26 (shown in the first embodiment only) thereon and the cable 22, 222, 322 can be used to connect to another antenna (not shown) not located on the printed wiring board 24, 224, 324. The connector 20, 220, 320 allows a user to easily insert and remove the printed wiring board 24, 224, 324 from the notebook computer and to replace the printed wiring board 24, 224, 324 with the same or another printed wiring board.

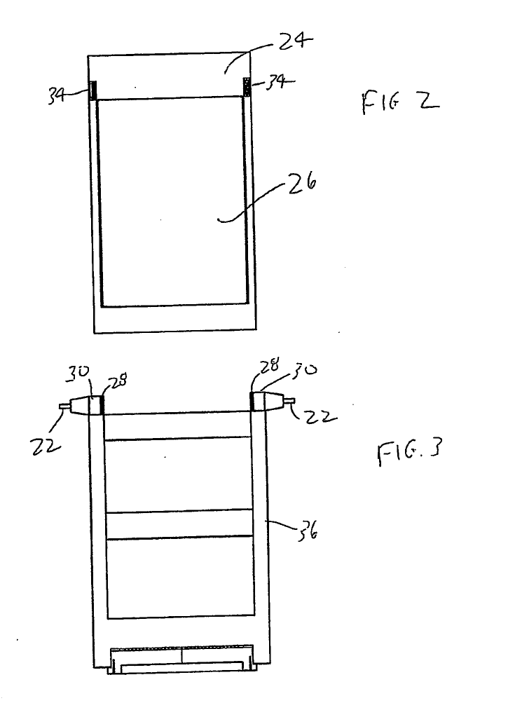

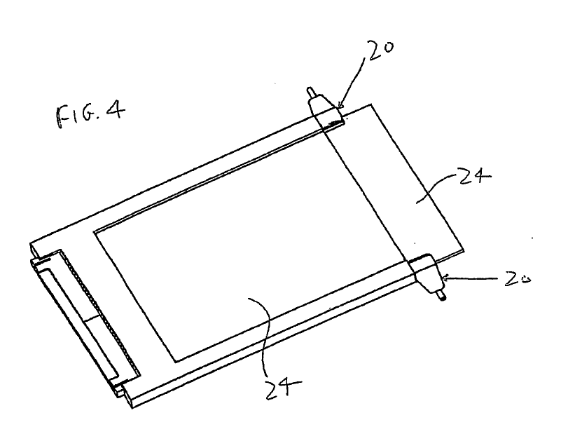

Attention is now invited to the first embodiment of the connector 20 shown in FIGS. 1-11. The connector 20 includes a non-conductive housing 28, a ground shield 30 which surrounds a portion of the housing 28, a conductive signal contact 32 mounted in the housing 28, and a spring connector 34. As shown in FIG. 2, a pair of the spring connectors 34 are mounted proximate the upper edge of the printed wiring board 24 along the opposite sides thereof. The spring connectors 34 are provided proximate to the antenna 26 in an area of the printed wiring board 24 which is usually unused, i.e., near the outer edge of the printed wiring board 24. As shown in FIG. 3, a pair of the housings 28, ground shields 30 and signal contacts 32 are mounted, either permanently or detachably, proximate the upper edge of a guide rail 36 along the opposite sides thereof. The cable 22 which is connected to the respective housing 28, ground shield 30 and signal contact 32 is mounted within the display portion of the notebook computer. The guide rail 36 is mounted within the display portion of the notebook computer and provides an opening at the upper edge of the display portion to allow for insertion of the printed wiring board 24 therein and removal of the printed wiring board 24 therefrom. The connector 20 is shown assembled with the cable 22 and the printed wiring board 24 in FIG. 1.

As best shown in FIGS. 7 and 11, the cable 22 is conventional and includes a signal conductor 38 and a ground wire drain 40 or foil or metallic braided shield surrounded by a jacket 42.

The printed wiring board 24 is conventional and is formed from non-conductive planar substrate having circuitry which provides the antenna 26 and conductive contact pads connected to the circuitry. The contact pads are proximate the edges of the printed wiring board 24 at the points where the spring connectors 34 are mounted.

The housing 28 is preferably integrally formed from plastic and is generally U-shaped. As best shown in FIG. 5, the housing 28 is formed from a base 44 which has upper and lower legs 46, 48 (shown inverted in FIG. 5) extending therefrom, and a lip 50 which extends downwardly from the upper leg 46.

The base 44 is generally rectangular and has an outer surface, an inner surface, a right surface and a left surface. As shown in FIG. 7, the outer surface of the base 44 includes a first passageway 52 of a predetermined depth therein. A second passageway 54 is provided within the first passageway 52 and has a predetermined depth. At least a portion of the second passageway 54 is provided at approximately the center of the base 44. As shown, the passageways 52, 54 are generally rectangular, however, other shapes may be provided. As shown in FIG. 11, a passageway 56 is provided through the base 44 from the inner surface to the second passageway 54.

The upper leg 46 is rectangular and has an outer surface, an inner surface, a right surface and a left surface. The upper leg 46 extends perpendicularly from the inner surface of the base 44 at an upper end thereof. The inner surface of the upper leg 46 faces the lower leg 48.

The lip 50 extends perpendicularly downwardly from the opposite end of the upper leg 46 at approximately the midpoint thereof. The lip 50 extends a predetermined distance toward the lower leg 48. The lip 50 has a right side portion 50a which has an upper surface which extends downwardly from the upper leg 46 and is angled relative to the upper leg 46, a left side portion 50b which has an upper surface which extends downwardly from the upper leg 46 and is angled relative to the upper leg 46, and a middle portion 50c which has a top surface which is parallel to the upper leg 46 and is between the right side surface and the left side surface. An elongated aperture 56 is provided through the middle portion.

The lower leg 48 is rectangular and has an outer surface 48a, an inner surface 48b, a right surface 48c and a left surface 48d. The lower leg 48 extends perpendicularly from the inner surface 44a of the base 44 at a lower end thereof. The inner surface of the lower leg 48 faces the upper leg 46. The lower leg 48b is longer in length than the upper leg 46 relative to the inner surface 44a of the base 44.

A receptacle 31 is provided within the housing 28 and is defined by the inner surface 44a of the base 44, the inner surfaces of the legs 46, 48 and the lip 50.

The ground shield 30 is preferably formed from metal. As shown in FIGS. 6 and 7, the ground shield 30 has an upper plate 58, a lower plate 60, a right side plate 62 and a left side plate 64. The right side plate 62 connects the upper and lower plates 58, 60 together at one end thereof. The left side plate 64 connects the upper and lower plates 58, 60 together at the opposite end thereof.

The upper plate 60 has a planar main portion 66 which substantially covers the outer surface of the upper leg 46 of the housing 28. A tab 68 extends downwardly from the main portion 66 and engages into the first passageway 52 in the base 44. The tab 68 is provided at approximately the midpoint of the first passageway 52 and accordingly is aligned with the second passageway 54. A generally L-shaped portion 70 is provided at the opposite end of the main portion 66. The generally L-shaped portion 70 is formed from a vertical arm, and a horizontal arm which is generally perpendicular to the vertical arm and parallel to the main portion 66. The vertical arm extends partially over the outer surface of the lip 50. The horizontal arm extends outwardly from the outer surface of the lip 50 a predetermined distance.

The right side plate 62 substantially covers the right surfaces of the base 44, the upper leg 46 and the lower leg 48. The left side plate 62 substantially covers the left surfaces of the base 44, the upper leg 46 and the lower leg 48.

The lower plate 60 has a planar main portion 72 which substantially covers the outer surface of the lower leg 48. A pair of spaced apart tabs 74 extend downwardly from the main portion 72 and engage into the first passageway 52 in the base 44. The tabs 68, 74 secure the ground shield 30 to the housing 28.

The conductive signal contact 32 is generally formed as a lazy Z-shape, and includes an inner section 76, an outer section 80 and a middle section 78 which separates the inner section 76 from the outer section 80. The inner section 76 is parallel to the outer section 80, and the middle section 78 is generally perpendicular to the inner and outer sections 76, 80. The inner section 76 includes a first end 76a and a second end 76b and the outer section 80 includes a first end 80a and a second end 80b. The middle section 78 is connected to the second end of the inner section 76 and to the first end of the outer section 80. The first end of the inner section 76 is mounted within the aperture 56 in the lip 50. The inner section 76 extends therefrom through the passageway 54 in the base 44 and sits against the inner surface of the upper leg 46. The middle section 78 is positioned within the second passageway 54 in the base 44. The outer section 80 extends into the first passageway 52 in the base 44, but the second end thereof does not extend outwardly of the first passageway 52.

The cable 22 is electrically connected to the signal contact 32 and to the ground shield 30 as best shown in FIGS. 7 and 11. The signal conductor 38 is affixed, such as by welding, to the signal contact 32. The drain wire 40 is affixed, such as by welding, to the tab 68 on the ground shield 30. A non-conductive overmolding 82 can be provided around the cable 22 and the outer surface of the base 44 to protect the connection points between the cable 22 and the connector 20.

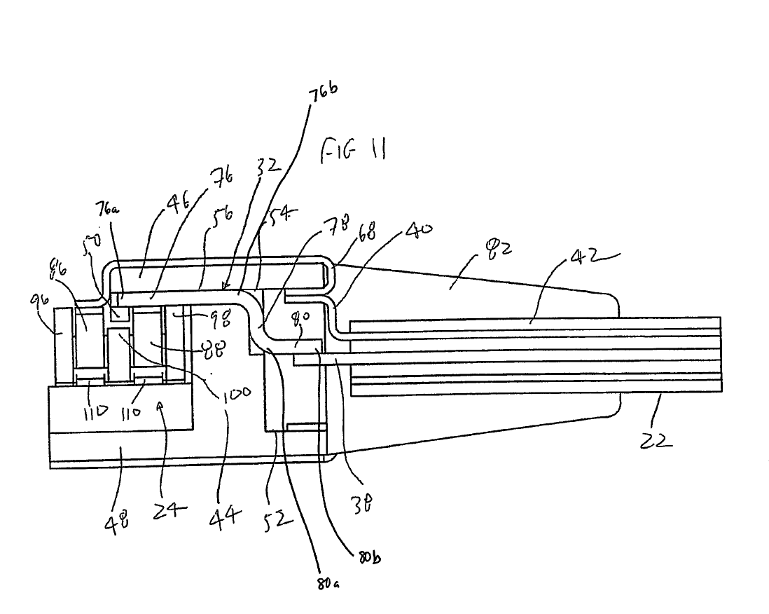

As best shown in FIGS. 8-10, the spring connector 34 includes a non-conductive body 84, a conductive spring ground terminal 86 mounted in the body 84 and a conductive spring signal terminal 88 mounted in the body 84.

The body 84 is preferably integrally formed from plastic. The body 84 has a rectangular base 90 which has a ground passageway 92 provided therethrough and a signal passageway 94 provided therethrough. The ground passageway 92 is spaced apart from the signal passageway 94 and separated therefrom by a portion of the base 90. The base 90 has an upper surface, a lower surface, a right side surface, a left side surface, a first end surface and a second end surface.

An upper right wall 96 extends upwardly along the entire length of the upper surface, proximate the right surface. The ends 96a of the upper right wall 96 taper inwardly from the base 90. An upper left wall 98 extends upwardly along the entire length of the upper surface, proximate the left surface. The ends 98a of the upper left wall 98 taper inwardly from the base 90. The upper right wall 96 and the upper left wall 98 have substantially the same height A middle wall 100 is provided between the passageways 92, 94 and extends along the entire length of the upper surface of the base 90. The ends 100a of the middle wall 100 taper inwardly from the base 90. The middle wall 100 has a height which is less than the height of the upper right wall 96 and of the upper left wall 98.

Locating pegs 102 are provided proximate the ends of the base 90 and extend outwardly from approximately the midpoint of the lower surface. The locating pegs 102 are generally cylindrical and have a rounded lower edge. The locating pegs 102 engage into corresponding locating holes provided in the printed wiring board 24 and are secured thereto by suitable means. A foot 104 extends outwardly from the bottom surface at each of the corners of the base 90. Each foot 104 has a height which is substantially less than the height of the locating pegs 102.

Each passageway 92, 94 extends from the upper surface 90a of the base 90 to the lower surface 90b thereof. As best shown in FIG. 9, the ground passageway 92 has an upper portion 106 which extends along substantially the entire length of the base 90, and a lower portion 108 which extends along approximately half of the length of the base 90. The signal passageway 94 is identically formed to the ground passageway 92.

The spring ground terminal 86 is formed of a generally C-shaped spring arm mounted in the body 84 and which is deflectable relative to the body 84. The spring arm of the spring ground terminal 86 has a first portion 110 which is flat and is parallel to the bottom surface of the base 90, a second portion 112 which extends from the first portion 110 and which is insert molded within the base 90 proximate to the bottom surface thereof, a third portion 114 which extends from the second portion 112 and is generally U-shaped, a fourth portion 116 which extends from the third portion 114 and is angled upwardly relative thereto, a fifth portion 118 which extends from the fourth portion 116 and which is curved, a sixth portion 120 which extends from the fifth portion 118 and is angled downwardly relative thereto, and a tip portion 122 which is curved downwardly relative to the sixth portion 120. The first portion 110 is positioned within the lower portion 108 of the ground passageway 92 and provides the contact point with the associated contact pad on the printed wiring board 24. The third, fourth, fifth, sixth and tip portions 114, 116, 118, 120 and 122 are free to move within the ground passageway 92 and can be deflected relative to the base 90 into the ground passageway 92 upon the application of downward pressure to the fifth portion 118. In the undeflected position, a section of the fourth portion 116, the fifth portion 118 and a section of the sixth portion 120 extend upwardly from the base 90. The spring signal terminal 88 is identically formed and mounted in the signal passageway 94 in the identical manner. Instead of insert molding the second portion 112 with the base 90, other means of attaching the spring terminals 86, 88 with the base 90 are within the scope of the present invention.

To mount the printed wiring board 24 which has the spring connectors 34 thereon into the guide rail 36, the printed wiring board 24 is slid into the guide rail 36. The printed wiring board 24 and the spring connectors 34 will slide into the receptacles 31 provided within the housings 28. The tapered end surfaces of the walls 96a, 98a, 100a aid in inserting the spring connector 34 into the receptacle 31. In each connector 20, the spring ground terminal 86 engages with the horizontal arm of the generally L-shaped portion 70 of the ground shield 30 and the third, fourth, fifth, sixth and tip portions 114, 116, 118, 120 and 122 may move within the ground passageway 92. In each connector 20, the spring signal terminal 88 engages with the inner section 76 of the conductive signal contact 32 and the third, fourth, fifth, sixth and tip portions of the spring signal terminal 88 may move within the signal passageway 94.

Once fully inserted into the guide rail 36, the electrical signals pass from the printed wiring board 24, through the spring signal terminal 88 in the respective spring connector 34, through the respective signal contact 32 and through the respective signal conductor 38 in the cable 22.

The printed wiring board 24 which has the spring connectors 34 thereon can be easily removed from the guide rail 36 and the housings 28, ground shields 30 and signal contacts 32 by simply pulling it outwardly from the display portion of the notebook computer. The spring terminals 86, 88 will deflect as necessary for removal of the printed wiring board 24.

Alternatively, rather than having a separate spring connector 34, the signal and ground terminals 86, 88 can be mounted directly to the printed wiring board 24 either in the form of terminals or contact pads.

Attention is now invited to the second embodiment of the connector 220 shown in FIGS. 12-18. The connector 220 is intended for use at any frequency up to 6 GHz, and possibly to 10 GHz. The connector 220 is small and has a thickness of approximately 2.5 mm, a width of approximately 4 mm and a length of approximately 5 mm.

The printed wiring board 224 includes a plurality of surfaces, of which a bottom surface 226 and a top surface 228 are the most relevant to the second embodiment of the present invention. The printed wiring board 224 has a predetermined height defined between the bottom surface 226 and the top surface 228. The top surface 228 of the printed wiring board 224 has a signal contact 230 integrally formed thereon and a ground contact 232 integrally formed thereon which is spaced apart from the signal contact 230. The signal contact 230 and the ground contact 232 are raised above the top surface 228 of the printed wiring board 224. As shown, the signal contact 230 and the ground contact 232 are hemispherical, however, other shapes may be provided.

The cable 222 has an outer conductor 234 and an inner, signal conductor 236. The outer conductor 234 may be formed of braided wires over insulation. The braided wires may be impregnated with tin to provide rigidity. The impregnation can be accomplished by dipping the end of the cable 222 into a solder bath, or using “conformable” cable which is impregnated by the producer. Other methods of providing rigidity to the braided wires may also be used, such as a metallic cylinder around the braided wires. The inner signal conductor 236 may be a bundle of strands of wire or a single wire at the center of the cable 222, and is concentric to the outer conductor 234.

The connector 220 has a ground shield 238 which is formed of a conductive material, such as sheet metal. The ground shield 238 includes a rear wall 240, a bottom wall 242, a top wall 244, a left side wall 246 and a right side wall 248 which generally form an open-ended box. The bottom, top, left side and right side walls 242, 244, 246, 248 are connected to respective outer edges of the rear wall 240. Lower and upper edges of the left side wall 246 are respectively connected to left side edges of the bottom wall 242 and the top wall 244; lower and upper edges of the right side wall 248 are respectively connected to right side edges of the bottom wall 242 and the top wall 244. Front edges of the bottom, top, left side and right side walls 242, 244, 246, 248 are coplanar. A receptacle 250 is provided within the ground shield 238 and is defined by the walls 240, 242, 244, 246, 248.

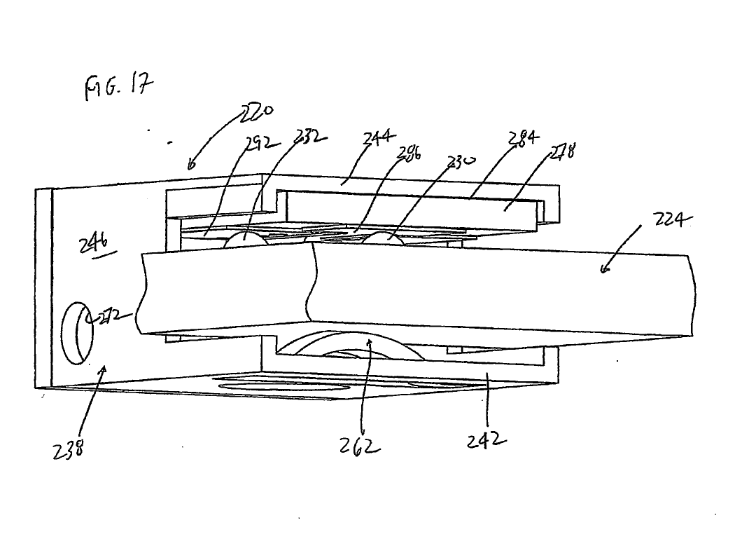

As best illustrated in FIG. 15, the rear wall 240 includes an upside-down, generally T-shaped opening 252 therethrough which is formed from a lower horizontal leg 254 and an upper vertical leg 256. The lower leg 254 is rectangularly-shaped and is proximate the bottom edge of the rear wall 240. The lower leg 254 spans substantially the entire width of the rear wall 240. The upper leg 256 is provided at the midpoint of the lower leg 254 and the midpoint of the rear wall 240 and is generally square. A tapered section 258 is provided between the lower and upper legs 254, 256 to promote entrance of the cable 222 therein as described herein.

The bottom wall 242 has a generally rectangular opening 260 therein proximate to, but spaced from the front edge thereof. The rectangular opening 260 spans approximately the entire width of the bottom wall 242. A rear edge of the opening 260 is at a predetermined distance from the front edge of the bottom wall 242. An integrally formed spring connector 262, which takes the form of an arm that is deflectable relative to the bottom wall 242, is provided within the opening 260 and has a rear end 262a integrally formed with the bottom wall 242 at a right side edge of the opening 260. The remainder of the spring connector 262 is free to move within the opening 260. The spring connector 262 includes a flat portion 264 which is integrally formed with and extends from the bottom wall 242 and a curved portion 266 which extends from the flat portion 264. In an at rest position, the flat portion 264 is flush with the bottom wall 242 and the curved portion 266 extends inwardly into the receptacle 250 a predetermined distance. An aperture 268 is provided through the bottom wall 242 and is provided between the rectangular opening 260 and the rear edge of the bottom wall 242. As shown, the aperture 268 is circular, but may take on other shapes.

The left side wall 246 has a generally U-shaped recess 270 starting at the front edge thereof and extending rearwardly a predetermined distance. A rear edge of the recess 270 is spaced from the front edge of the left side wall 246 a distance which is greater than the predetermined distance the rear edge of the opening 260 in the bottom wall 242 is spaced from the front edge of the bottom wall 242. An aperture 272 is provided in the left side wall 246 proximate the rear and bottom edges of the left side wall 246.

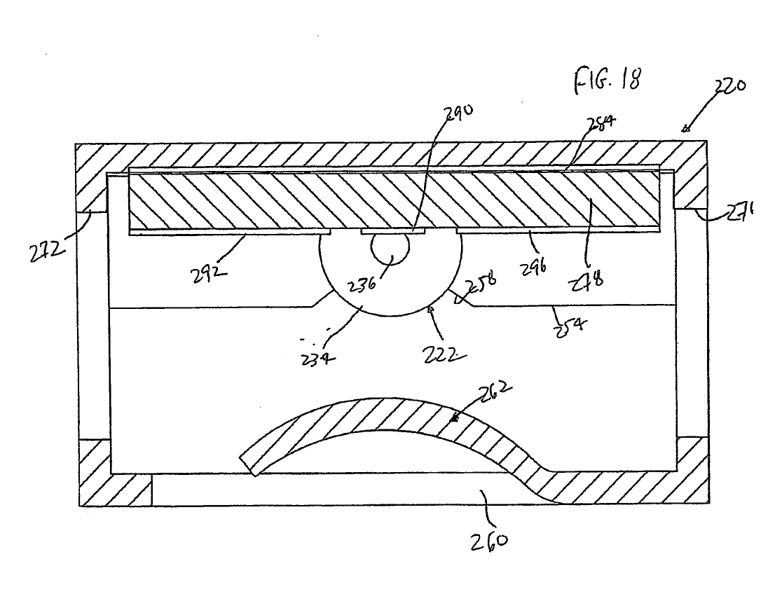

As best illustrated in FIG. 16, the right side wall 248 is identically formed to the left side wall 246. Accordingly, the right side wall 248 has a generally U-shaped recess 274 starting at the front edge thereof and extending rearwardly a predetermined distance. A rear edge of the recess 274 is spaced from the front edge of the right side wall 248 a distance which is greater than the predetermined distance the rear edge of the rectangular opening 260 in the bottom wall 242 is spaced from the front edge of the bottom wall 242. An aperture 276 is provided in the right side wall 248 proximate the rear and bottom edges of the right side wall 248. Aperture 276 is aligned with aperture 272.

A housing 278 is provided within the receptacle 250 and acts as a spacer and insulator. The housing 278 is formed of a dielectric material and has a predetermined height defined between a bottom surface thereof and a top surface thereof. A left hand set of spaced-apart through apertures 279a are provided through the housing 278 along a portion thereof. Each aperture is plated with a conductive material. A right hand set of spaced-apart through apertures 279b are provided through the housing 278 along a portion thereof. Each aperture is plated with a conductive material. The top surface of the housing 278 has a layer 284 formed of a conductive material, preferably copper, provided thereon. The conductive material can be pressure fit or soldered to the housing 278. Accordingly, the plating in the through apertures are electrically connected to the conductive layer 284. The housing 278 can be a printed wiring board.

The housing 278 is mounted within the receptacle 250 and the conductive layer 284 abuts the inner surface of the top wall 244 of the ground shield 238. The predetermined height of the housing 278 is such that the bottom surface 278a of the housing 278 extends above the top edges of the recesses 270, 274 in the left and right side walls 246, 248.

A conductive, generally T-shaped signal contact 286 is mounted on a bottom surface 278a of the housing 278. The signal contact 286 is formed from a first leg 288 and a second leg 290 which is perpendicular to the first leg 288. The first leg 288 is generally rectangular and has a front edge which is proximate to, but spaced from, the front edge of the housing 278. The second leg 290 extends rearwardly from the first leg 288 toward a rear edge of the housing 278. The signal contact 286 is mounted on the housing 278 such that the second leg 290 is a centrally located on the housing 278 and aligns with the upper leg 256 of the opening 252 in the rear wall 240. The signal contact 286 is preferably welded or soldered to the housing 278.

As shown in FIG. 12, a left side ground contact 292 is mounted on the bottom surface of the housing 278 to the left side of the second leg 290. A rear edge of the ground contact 292 is aligned with a rear edge of the housing 278. A left side edge of the ground contact 292 is aligned with a left side edge of the housing 278 and a right side edge of the ground contact 292 is spaced from the second leg 290. A plurality of spaced apart through apertures 294 are provided through the ground contact 292 proximate a right side edge thereof. The through apertures 294 in the left side ground contact 292 align with the apertures in the left hand set in the housing 278 and are in electrical contact therewith. A right side ground contact 296 is mounted on the bottom surface of the housing 278 to the right side of the second leg 290. A rear edge of the ground contact 296 is aligned with a rear edge of the housing 278. A right side edge of the ground contact 296 is aligned with a right side edge of the housing 278 and a left side edge of the ground contact 296 is spaced from the second leg 290. The through apertures 294, 298 can be plated vias, thereby extending the ground to the outer portion of the ground shield 238. Alternatively, the housing 278 can be a printed wiring board or other type of substrate that includes the signal contact 286 and ground contacts 292, 296 thereon, with the printed wiring board having vias therethorugh to allow the ground contacts to be in electrical contact with the ground shield 238. By this technique, the ground contacts 292, 296 can be coplanar with the signal contact 286, while at the same time the outer portion of the ground shield 238 is maintained as a ground.

Because the signal contact 286 is centrally located on the housing 278 and two ground contacts 292, 296 are provided on either side thereof, the connector 220 is symmetrical.

The arrangement of the housing 278, the conductive layer 284, the apertures through housing 278, the signal contact 286, and the ground contacts 292, 296 provide for coplanar impedance control.

To assemble the cable 222 with the connector 220, the cable 222 is inserted into the lower leg 254 of the opening 252 in the rear wall 240. Thereafter, the cable 222 is forced into the upper leg 256 of the opening 252, passing through the tapered section 258. As a result, the connection to the outer conductor 234 is made using a technique similar to the insulation displacement technique used on individual wires wherein the insulated wire is pushed into a wedge formed of sheet metal. The inner signal conductor 236 extends outwardly from the outer conductor 234 a predetermined distance. The inner signal conductor 236 makes an electrical connection with the second leg 290 of the signal contact 286. The inner signal conductor 236 can be soldered or welded to the signal contact 286 by inserting the appropriate tools through the aperture 268. An outer boot 300 can be provided to cover the connection of the cable 222 to the rear wall 240 of the ground shield 238.

The printed wiring board 224 is connected to the connector 220 by inserting the printed wiring board 224 into the open front end of the connector 220. Because of the symmetry of the connector 220, the printed wiring board 224 can be inserted from either the left hand side of the connector 220 or the right hand side of the connector 220 and connected to the signal contact 286 and one of the ground contacts 292, 296, depending on which side the printed wiring board 224 is inserted. Accordingly, the printed wiring board 224 can be inserted through the recess 270 in the left side wall 246 of the housing 228 or through the recess 274 in the right side wall 248 of the ground shield 238. As the printed wiring board 224 is inserted into the ground shield 238, the spring connector 262 flexes, but maintains the tendency to return to its original at rest position. The printed wiring board 224 is captured between the housing 278 and the spring connector 262. The spring connector 262 abuts against a lower surface of the printed wiring board 224 and forces the signal contact 230 and the ground contact 232 of printed wiring board 224 into engagement with the signal contact 286 and the appropriate ground contact 292, 296. The electrical connection that is made between the cable 222, the connector 220 and the printed wiring board 224 provides high frequency performance. This requires impedance matching between the cable 222 and the printed wiring board 224, as well as mechanical considerations including mounting and service life. The connector 220 provides impedance matched and mechanically reliable contacts that connect the outer conductor 234 and the inner signal conductor 236 to the printed wiring board 224. It is presumed that the printed wiring board 224 is impedance matched, and can be designed to be compatible with the connection to the connector 220.

Adequate electrical connection requires that acceptable pressure as well as wiping action at the time the connection is made between the connector 220 and the printed wiring board 224. This assures that any oxides or other non-conductive contaminants are removed. The contact pressure for high frequency connection does not require as much pressure as low frequency connections because of the capacitive coupling effect of two conductors in close proximity. The usual approach is to have one of the contacts in each pair (inner and outer) be resilient so spring action provides the required normal force at the point of contact, and the mating includes a sliding action after the normal force is applied, to assure any contaminants are wiped away. In the connector 220, the contacts 286, 292, 296 are not resilient and instead are rigid and designed to optimize the impedance.

Various manufacturing processes can be utilized to form the components of the connector 220 including stamping, molding, plated plastics, machining etc.

Overmolding, shrink tubing or other strain relief techniques may be added to enhance some characteristics of the connector 220.

Grounding is provided through the connection to the cable 222. The cable 222 is electrically connected to the ground shield 238 by the connection of the outer conductor 234 to the ground shield 238. This electrical connection is preferably made using insulation displacement techniques. The ground shield 238 is electrically connected to the conductive layer 284, which is electrically connected to the plated through holes through the support member 278, and which is electrically connected to the ground contacts 292, 296. The ground contact 232 of the printed wiring board 224 is electrically connected to one of the ground contacts 292, 296 when the printed wiring board 224 is inserted into the connector 220.

The signal from the inner signal conductor 236 of the cable 222 passes through the signal contact 286 on the support member 278 and to the signal contact 230 of the printed wiring board 224.

To ensure that the connector 220 is capable of being properly aligned with the printed wiring board 224 such that the printed wiring board 224 can be inserted therein, a pin (not shown) can be provided through the aligned apertures 272, 276 for allowing the connector 220 to rotate therearound. The pin is fixed to an outside component. Because the connector 220 can rotate, the connector 220 can be moved to an aligned position with the printed wiring board 224.

Attention is now invited to the third embodiment of the connector 320 shown in FIGS. 19-27. The connector 320 is intended for use at any frequency up to 6 GHz, and possibly to 10 GHz. The connector 320 is small and has a thickness of approximately 2.5 mm, a width of approximately 4 mm and a length of approximately 5 mm.

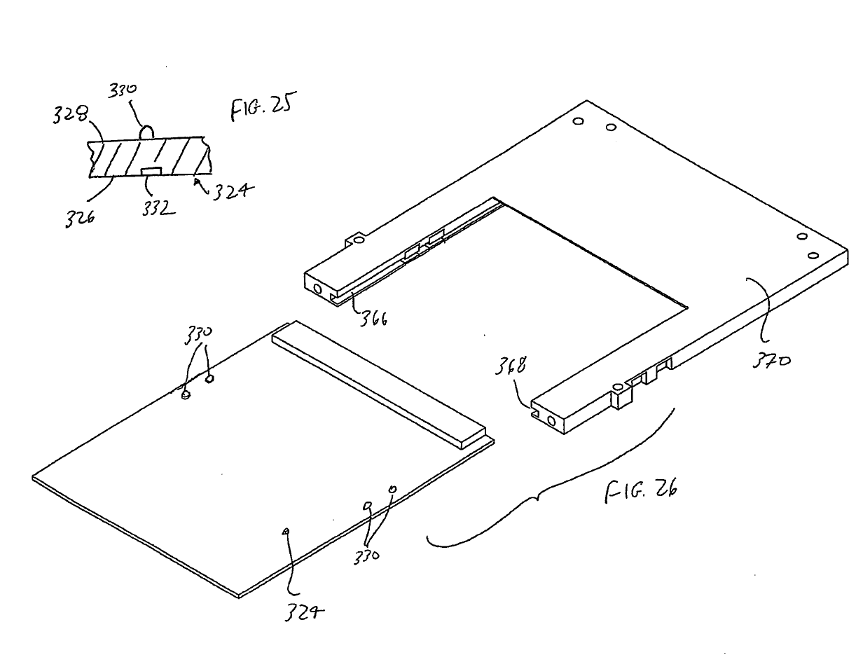

As shown in FIG. 25, the printed wiring board 324 includes a plurality of surfaces, of which a bottom surface 326 and a top surface 328 are the most relevant to the present invention. The printed wiring board 324 has a predetermined height defined between the bottom surface 326 and the top surface 328. The top surface 328 of the printed wiring board 324 has a signal contact 330 integrally formed thereon and the bottom surface 326 has a ground contact 332 integrally formed thereon which is generally aligned with the signal contact 330. The signal contact 330 is raised above the top surface 328 of the printed wiring board 324. The ground contact 332 is flush with the bottom surface 326 of the printed wiring board 324. As shown, the signal contact 330 is hemispherical, however, other shapes may be provided.

The cable 322 is conventional and includes an outer conductor 334 and an inner signal conductor 336. The outer conductor 334 is surrounded by a jacket 337. In addition, a non-conductive layer 335 is located between the signal conductor 336 and the outer conductor 334.

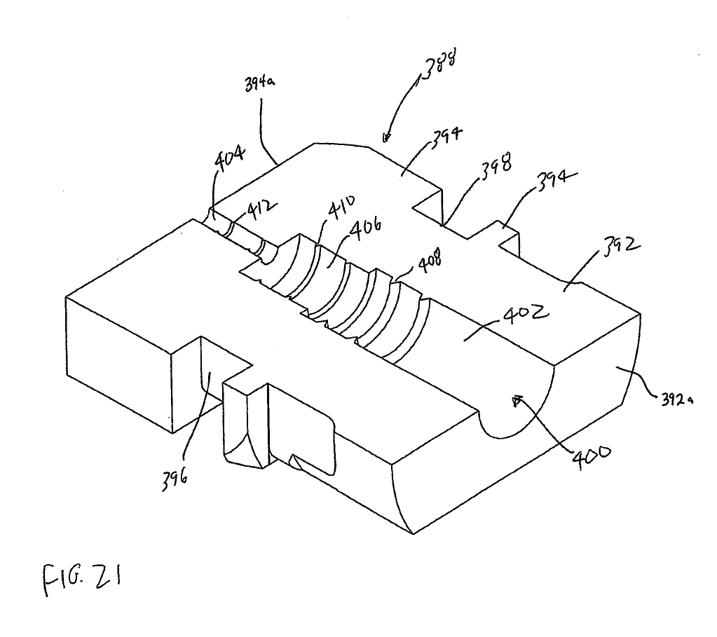

As shown in FIGS. 19 and 20, the connector 320 has a ground member 338 which is formed of a conductive material, such as sheet metal. The ground member 338 includes a rear wall 340, a pair of wings 342, 344 that extend from the rear wall 340, a spring connector 346 and a pair of arms 348, 350 that extend from the spring connector 346.

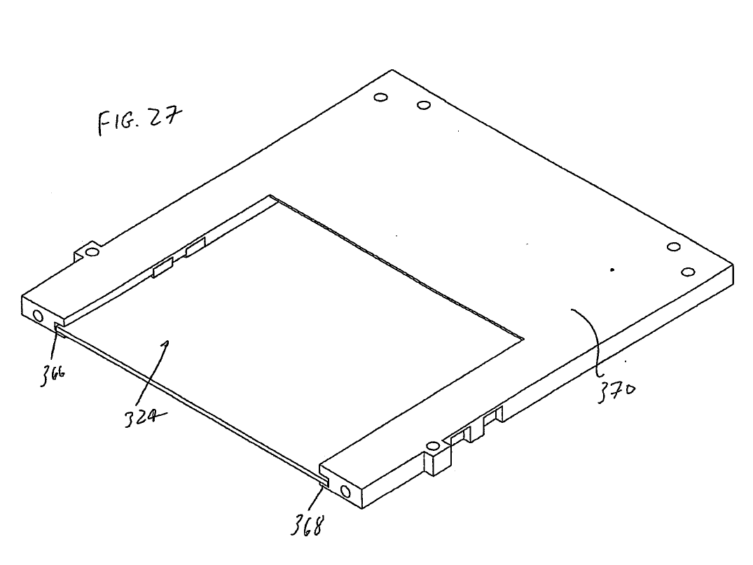

The rear wall 340 has a base 352 and a pair of curved ends 354, 356 at the opposite ends thereof A wing 342, 344 extends from the respective curved end 352, 356. Each wing 342, 344 is L-shaped and has first leg 358, 360 that depends from the respective curved end 354, 356 and a second leg 362, 364 which is generally perpendicular to the first leg 358, 360. The second legs 362, 364 have a series of a curves therein to form convolutions. The rear wall 340 and the wings 342, 344 form a space 345. The wings 342, 344 are used to connect to guide rails 366, 368, FIGS. 26 and 27, mounted within the device, for example, a display portion 370 of the notebook computer. The guide rails 366, 368 provide an opening at the upper edge of the display portion 370 to allow for insertion of the printed wiring board 324 therein and removal of the printed wiring board 324 therefrom.

As shown in FIGS. 19 and 20, the spring connector 346 is an elongated arm that extends from the midpoint of the base 352 of the rear wall 340 and is generally perpendicular thereto. The elongated arm is deflectable relative to the base 352. In an undeflected position, an upper surface of the spring connector 346 is planar with an upper surface of the base 352 and a lower surface of the spring connector 346 is planar with a lower surface of the base 352. A dimple 372 is provided at the free end of the spring connector 346 and extends from the upper surface of the spring connector 346.

Each arm 348, 350 is generally L-shaped and has a first horizontal portion 374, 376 and a second vertical portion 378, 380 which depends generally perpendicularly thereto. A rounded tip 382 (only shown on arm 348 in the drawings) is provided on the end of each vertical portion 378, 380 and the tips 382 extend inwardly toward each other. As a result, a receptacle 384 is formed by the arms 348, 350 and the portion of the spring connector 346 that is between the first portions 374, 376 of the arms 348, 350. The arms 348, 350 extend outwardly from the spring connector 346 at a predetermined distance spaced away from the rear wall 340. When the ground member 338 is not attached to other components of the connector 320, the second portions 378, 380 of the arms 348, 350 extend inwardly toward each other.

The connector 320 includes a housing 386 formed of a lower body 388 and an upper body 390. The housing 386 is mounted within the space 345 and the receptacle 384 as discussed herein.

The lower body 388 is formed of a single piece of insulative material, such as plastic. The lower body 388 has a rear portion 392 which is generally rectangular and a front portion 394 which is generally rectangular. The width of rear portion 392 is smaller than the width of the front portion 394. The rear and front portions 392, 394 provide a planar upper face along the length of the lower body 388. A recessed section 396, 398 is provided along the length of the front portion 394 toward the rear end thereof on each side of the front portion 392.

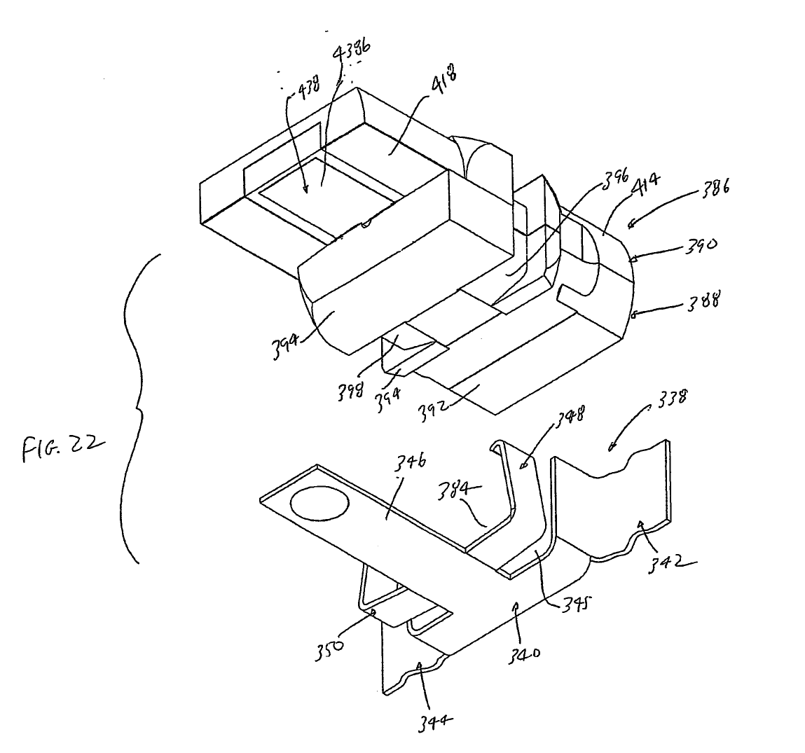

As shown in FIG. 21, the upper face of the lower body 388 has a recess 400 which extends from a rear end 392a of the lower body 388 to a front end 394a of the lower body 388. The recess 400 is parallel to the axial centerline of the lower body 388. The recess 400 has a rearward section 402 which extends from the rear end 392a of the rear portion 392, along the length of the rear portion 392 and partially into the front portion 394. The recess 400 has a forward section 404 which extends from the front end of the lower body 388 along the length of the front portion 394 a predetermined distance. The recess 400 has a middle section 406 which extends between the rearward and forward sections 402, 404. The rearward section 402 is larger in dimension than the middle section 406. The middle section 406 is larger in dimension than the forward section 404. As shown, the rearward, forward and middle sections 402, 404, 406 of the recess 400 are hemispherical, however, other shapes may be used.

A plurality of spaced apart raised ribs 408, 410, 412 extending toward the center of the recess 400 are provided along the forward end of the rearward section 402, the middle section 406 and the forward section 404. Each rib 408, 410, 412 terminates in a line.

The upper body 390 has a rear portion 414 which is generally rectangular, a middle portion 416 which is generally rectangular and a front portion 418 which is generally rectangular. The middle portion 416 extends between the rear and front portions 414, 418. The width of the middle and front portions 416, 418 are approximately the same and is greater than the width of the rear portion 414. The height of the rear portion 414 and the middle portion 416 are the same and is greater than the height of the front portion 418. The rear, middle and front portions 414, 416, 418 provide a planar lower face along the length of the upper body 390. A recessed section 420, 422 is provided along the length of the middle portion 416 toward the rear end thereof on each side of the middle portion 416.

The lower face of the upper body 390 has a recess 424 which extends from a rear end 414a of the upper body 390 towards a front end 418a of the upper body 390. The recess 424 terminates a predetermined distance away from the front end of the front portion 418 of the upper body 390. The recess 424 is parallel to the axial centerline of the upper body 390. The recess 424 has a rearward section 426 which extends from the rear end of the rear portion 414, along the length of the rear portion 414 and partially into the middle portion 416. The recess 424 has a forward section 428 which extends from the front end of the recess 424 in the front portion 418 and partially into the middle portion 416. A middle section 430 of the recess 424 extends between the rearward and forward sections 426, 428. The rearward section 426 is larger in dimension than the middle section 430. The middle section 430 is larger in dimension than the forward section 428. As shown, the rearward, forward and middle sections 426, 428, 430 of the recess 424 are hemispherical, however, other shapes may be used.

A plurality of spaced apart raised ribs 432, 434, 436 extending toward the center of the recess 424 are provided along the forward end of the rearward section 426, the middle section 430 and the forward section 428. Each rib 432, 434, 436 terminates in a line.

The front portion 418 of the upper body 390 has a conductive signal contact 438 mounted thereon. A first portion 438a of the signal contact 438 is provided within the forward section 428 of the recess 424 and a second portion 438b is provided on the lower face of the front portion 418. The signal contact 438 is mounted to the front portion 418 by suitable means or can be plated onto the upper body 390.

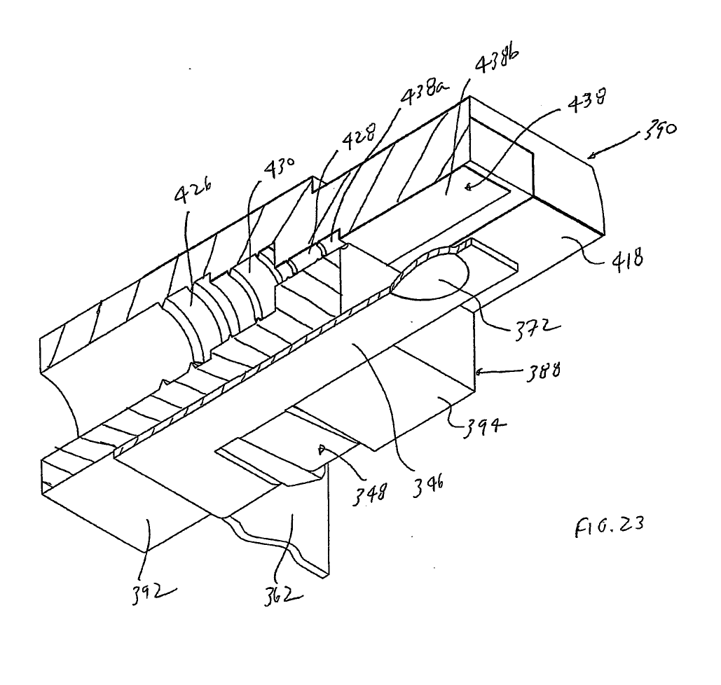

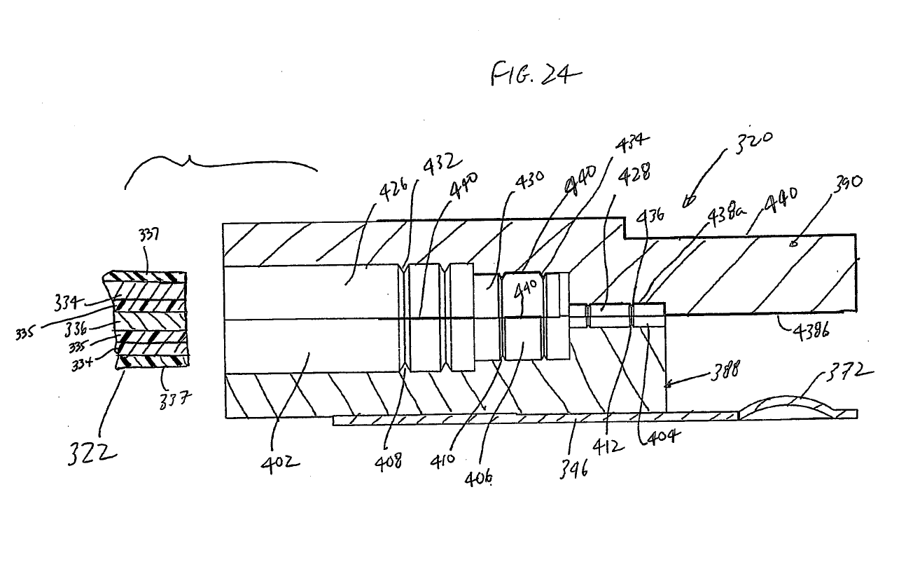

The upper body 390 is formed of a dielectric material that has predetermined portions which are covered with a conductive material 440. The signal contact 438 is completely surrounded by non-conductive portions of the upper body 390. As shown in FIG. 20, the stippled area shows the conductive material 440; and as shown in FIGS. 23 and 24, the thick line shows the conductive material 440. At a minimum, the conductive material needs to be provided on the middle section 430 of the recess 424, the recessed sections 420, 422 and the lower face of the upper body 390 between the middle section 430 of the recess 424 and the recessed sections 420, 422. The upper body 390 can be formed using a two-shot molding technique well-known in the art in which the non-plateable portions are first molded in a first shot, the plateable portions are overmolded in a second shot, and thereafter, the second shot is plated. Alternatively, the upper body 390 can be formed of a dielectric material that has a conductive member suitably attached thereto where the conductive material 440 is required. As an even further alternative, the entire upper body 390 can be formed of a conductive material, with only the portions surrounding the signal contact 438 being formed of a dielectric material.

To form the housing 386, the lower and upper bodies 388, 390 are abutted against each other. When the lower and upper bodies 388,390 are abutted, the planar upper face of the lower body 388 abuts the planar lower face of the upper body 390 and the rear ends of the lower and upper bodies 388, 390 align. The recesses 400, 424 align to form a passageway, such that the rearward sections 402, 426 align, the middle sections 406, 430 align and the front sections 404, 428 align. As shown, a cylindrical passageway is provided in the housing 386 when the lower and upper bodies 388, 390 are abutted. A section of the forward portion 418 of the upper body 390 extends beyond the front end 394a of the front portion 394 of the lower body portion 388. As a result, the portion 438b of the signal contact 438 is exposed.

To form the connector 320, the ground member 338 is attached to the housing 386. The base 352 of the rear wall 340 and the first portions 374, 376 of the arms 348, 350 sit against the lower surface of the lower body 388. A rear portion of the spring connector 346 sits against the lower surface of the lower body 388 and extends along the length of the lower body 388, such that the front portion of the spring connector 346 extends beyond the front end of the lower body 388. The legs 358, 360 of the wings 342, 342 sit against the sides of the lower and upper bodies 388, 390. The arms 348, 350 abut against the recessed sections 396, 398 on the lower body 388 and the recessed sections 420, 422 on the upper body 390 and the tips 382 extend along the upper surface of the upper body 390. During assembly, the arms 348, 350 flex outwardly when the housing 386 is inserted therein, but move toward their naturally inward state once seated within the recessed sections 396, 398, 420, 422 of the housing 386. As a result, a tight connection is made between the lower and upper bodies 388, 390 of the housing 386 and between the housing 386 and the ground member 338. The dimple 372 on the spring connector 246 aligns with the exposed portion 438b of the signal contact 438 on the lower face of the upper body 390.

Alternatively, the lower and upper bodies 388, 390 can be joined together, by mechanical fasteners, ultrasonic welding, cement or the like. The arms 348, 350 of the ground member 338 can then be eliminated, but other suitable means of attaching the ground member 338 to the housing 386 are provided.

The cable 322 is inserted into the passageway formed by the recesses 400, 424 and held therein by the ribs 408, 432 on the lower and upper bodies 38, 390. The ribs 408, 432 bite into the jacket 337 surrounding the outer conductor 334. A portion of the jacket 337 is stripped away (not shown) so that the outer conductor 334 is exposed and will contact the ribs 410, 434 in the middle sections 406, 430. The ribs 410, 434 in the middle sections 406, 430, are in pressure contact with the outer conductor 334 and ribs 434 are electrically connected to the outer conductor 334. Alternatively, the outer conductor 334 can be soldered or welded to the middle sections 406, 430 (the ribs 410, 434 may be eliminated, if desired). The inner signal conductor 336 is seated within the forward sections 404, 428. The ribs 412, 436 aid in securing the inner signal conductor 336 to the portion of the signal contact 438a in the forward sections 404, 428. If desired, solder can be used to secure the inner signal conductor 336 to the signal contact 438a. Grounding of the cable 322 is provided by the path provided by the outer conductor 336 contacting the conductive material 440 on the upper body 390, and the conductive material 440 on the upper body 390 contacting the ground member 338.

The wings 342, 344 of the connector 320 mount within a guide rail, for example guide rail 366. As shown, connectors 320 are provided on either side of the opening so that the printed wiring board 324 can be inserted therebetween.

The connector 320 is symmetrical and thus allows either the left side or the right side of the printed wiring board 324 to be inserted therein. The printed wiring board 324 is inserted in either the direction of the arrow A or the arrow B, FIG. 19, depending upon which side of the display portion 370 of the notebook computer the connector 320 is mounted.

When the printed wiring board 324 is inserted into the connector 320, the printed wiring board 324 slides between the spring connector 346 and the front portion 418 of the upper body 388. When the signal contact 330 on the printed wiring board 324 abuts the exposed signal contact 438b on the front portion 418, because the signal contact 330 on the printed wiring board 324 protrudes, this causes the spring connector 346 to flex away from the signal contact 438. This tends to cause the connector 320 to rotate within the respective guide rail, for example, guide rail 366, however, the convolutions on the second legs 362, 364 of the wings 342, 344 act as a torsional spring, which allows the housing 386 to rotate, to allow the contacts 330, 332 on the printed wiring board 324 to force the gap between the spring connector 346 and the housing 386 which contains the signal contact 438 to increase. When the printed wiring board 324 is removed, the torsional stress in the wings 342, 344 returns the housing 386 to the neutral position so the printed wiring board 324 can be inserted without drag until the contacts 330, 332 are engaged with the signal contact 438. The convolutions may not be required. The ground contact 332 on the bottom side of the printed wiring board 324 contacts the dimple 372 on the spring connector 346. The spring connector 346 will tend to return to its natural horizontal position and therefore, a good contact is provided between the ground contact 332 on the bottom side of the printed wiring board 324 and the dimple 372 on the spring connector 346.

Protrusions 442, only shown in FIG. 19, can be provided proximate the sides of the signal contact 438b and extend from the lower face of the front portion 418 of the upper body 390. The protrusions 442 can take the form of bumps, a taper, a ridge or the like, and are formed of the dielectric material of the upper body 390. When the printed wiring board 324 is inserted into the connector 320, the printed wiring board 324 will contact the taper, ridge or protrusions 442 to cause the spring connector 346 to flex away from the signal contact 438 on the front portion 418 of the upper body 390. This tends to cause the connector 320 to rotate within the respective guide rail, for example, guide rail 366, but the wings 342, 344 counteract this rotation as discussed herein. Because of the taper, ridge or protrusions 442, the printed wiring board 324 does not scrape across the surface of the signal contact 438b. The printed wiring board 324 slides between the spring connector 346 and the taper, ridge or protrusions 442 on the upper body 390. The signal contact 330 on the printed wiring board 324 extends outwardly from the printed wiring board 324 a greater distance than that provided by the taper, ridge or protrusions 442. When the signal contact 330 on the printed wiring board 324 abuts the signal contact 438b on the upper body 390, the spring connector 346 will still flex away from the signal contact 438. Any tendency for rotation caused by this flexing is negated by the convolutions on the wings 342, 344.

The structure of the connector 320 provide for coplanar impedance control. The electrical connection that is made between the cable 322, the connector 320 and the printed wiring board 324 provides high frequency performance. This requires impedance matching between the cable 322 and the printed wiring board 324, as well as mechanical considerations including mounting and service life. The connector 320 provides impedance matched and mechanically reliable contacts that connect the outer conductor 334 and the inner signal conductor 336 to the printed wiring board 324. It is presumed that the printed wiring board 324 is impedance matched, and can be designed to be compatible with the connection to the connector 320.

Adequate electrical connection requires that acceptable pressure as well as wiping action at the time the connection is made between the connector 320 and the printed wiring board 324. This assures that any oxides or other non-conductive contaminants are removed. The contact pressure for high frequency connection do not require as much pressure as low frequency connections because of the capacitive coupling effect of two conductors in close proximity.

Various manufacturing processes can be utilized to form the components of the connector 320. Overmolding, shrink tubing or other strain relief techniques may be added to enhance some characteristics of the connector 320.

Therefore, in the first embodiment of the connector 20, the spring connector 34 and the ground shield 30 are separate members; and in the second and third embodiments of the connector 220, 320, the spring connector 262, 346 are integrally formed with the ground shields 238, 338.

The cable 22 in the first embodiment of the connector 20 can be grounded to the ground shield 30 in the same manner as shown in the second embodiment by using insulation displacement, thereby eliminating the ground drain 40.

The taper, ridge or protrusions 442 can be provided in the second embodiments of the connector 220.

The terms upward, downward, right side and left side and the like have been used for ease in describing the components of the connector and do not mandate a required direction for use.

While the connectors 20, 220, 320 are shown for entry of the printed wiring board 24, 224, 324 from the side, modifications can be made to allow for entry of the printed wiring board 24, 224, 324 from the end. Such modifications are within the skill of one ordinary skill in the art.

While preferred embodiments of the present invention are shown and described, it is envisioned that those skilled in the art may devise various modifications of the present invention without departing from the spirit and scope of the appended claims.

The invention claimed is:

1. A connector for connecting a cable to a printed wiring board comprising:
a dielectric housing;
a conductive signal contact mounted on said housing and adapted for mating with a signal conductor of the cable; and
a spring connector connected to said housing, a receptacle defined between said spring connector and said housing, said spring connector having a deflectable arm for causing said signal contact on said housing to electrically connect to a signal contact on the printed wiring board when the printed wiring board is inserted into said receptacle.

2. A connector as defined in claim 1, wherein said spring connector is a separate member from said housing, such that said spring connector can be engaged and disengaged from said housing, said spring connector including a body and said deflectable arm is provided in said body.

3. A connector as defined in claim 2, wherein said deflectable arm is curved in an unflexed position.

4. A connector as defined in claim 2, further including a ground shield attached to said housing, said spring connector including ground means for connecting said ground shield to a ground contact on the printed wiring board.

5. A connector as defined in claim 4, wherein said ground means comprises a conductive ground terminal provided in said body.

6. A connector as defined in claim 5, wherein a portion of said ground terminal is capable of flexing relative to said body when the connection between said ground and shield and the ground terminal on the printed wiring board is made.

7. A connector as defined in claim 5, wherein said ground terminal is electrically isolated from said signal terminal in said body.

8. A connector as defined in claim 1, further including a ground shield attached to said housing and said deflectable arm is formed as part of said ground shield.

9. A connector as defined in claim 8, wherein said deflectable arm has a dimple thereon for engagement with a ground terminal on the printed wiring board.

10. A connector as defined in claim 1, wherein said receptacle provided has openings on two sides thereof into which the printed wiring board can be inserted.

11. A connector as defined in claim 10, wherein said signal contact is mounted at approximate the centerpoint of the receptacle.

12. A connector as defined in claim 1, further including a ground shield attached to said housing.

13. A connector as defined in claim 12, wherein said signal contact is generally mounted at approximate the centerpoint of the receptacle.

14. A connector as defined in claim 13, further including ground contacts provided on said housing on opposite sides of said signal contact and means for connecting said ground contacts with said ground shield.

15. A connector as defined in claim 14, further including a conductive layer provided between the housing and said ground shield.

16. A connector as defined in claim 12, wherein said ground shield includes an opening through which the cable is inserted, said opening having a first section which is larger than the cable to allow the cable to be freely inserted therein and second section which is smaller than the cable into which the cable can be inserted, thereby causing a secure connection between a ground conductor of the cable and said ground shield.

17. A connector as defined in claim 16, further including a tapered section between said first and second sections of said opening.

18. A connector as defined in claim 12, wherein said ground shield includes a pair of wings capable of being attached to a guide rail in a device.

19. A connector as defined in claim 18, wherein said wings have convolutions thereon.

20. A connector as defined in claim 1, wherein said signal contact is generally T-shaped.

21. A connector as defined in claim 20, further including a ground shield attached to said housing and ground contacts provided on said housing on opposite sides of said T-shaped signal contact, said ground contacts being electrically connected to said ground shield.

22. A connector as defined in claim 1, wherein said housing includes a passageway therein into which at least a portion of the cable is inserted.

23. A connector as defined in claim 22, wherein said signal contact extends into said passageway.

24. A connector as defined in claim 22, wherein said passageway includes a plurality of ribs therein for gripping the cable.

25. A connector as defined in claim 22, further including a ground shield attached to said housing.

26. A connector as defined in claim 25, wherein a portion of said passageway has a conductive material therein, said conductive material being electrically connected to said ground shield.

27. A connector as defined in claim 25, wherein a portion of said passageway has a conductive material therein, and a portion of said housing has a conductive material thereon, said conductive material in said passageway being electrically connected to said conductive material on said housing, and said conductive material on said housing being electrically connected to said ground shield.

28. A connector as defined in claim 22, wherein said housing is formed by first and second bodies which are joined together.

29. A connector as defined in claim 28, further including a ground shield which joins said first and second bodies together.

30. A connector as defined in claim 29, wherein said ground shield includes a pair of arms for joining said first and second bodies together.

31. A connector as defined in claim 29, wherein said ground shield includes a pair of wings capable of being attached to a guide rail in a device, said wings including convolutions thereon.

32. A connector as defined in claim 1, further including at least one protrusion formed of a dielectric material on the housing proximate to the signal contact.

33. A connector as defined in claim 1, further including a ground shield; said dielectric housing being connected to said ground shield; and a pair of ground contacts mounted symmetrically on the housing and electrically connected to the ground shield.

34. A connector as defined in claim 33, further including a plurality of plated through apertures provided through the housing for providing the electrical connection from the ground contacts to the ground shield.

35. A connector as defined in claim 33, wherein the signal contact is generally centrally located on the housing.

36. A connector as defined in claim 1, wherein said deflectable arm biases the printed wiring board against said signal contact mounted on said housing.

37. A connector as defined in claim 36, further including a ground shield, said dielectric housing being connected to said ground shield, and a pair of ground contacts mounted symmetrically on the housing and electrically connected to the ground shield; and wherein when said deflectable arm biases the printed wiring board, a ground contact on the printed wiring board is engaged against one of said ground contacts mounted on said housing.
